(19) United States
(12) Patent Application Publication
(10) Pub. No.: US 2021/0246006 A1
(43) Pub. Date: Aug. 12, 2021

(54) Adjustable Height Mobile Carrier

(71) Applicant: Rodeo Turtle LLC, Wellington, CO (US)

(72) Inventors: Jonathan M. Meadows, Wellington, CO (US); Donald R. Rockwell, Centennial, CO (US)

(73) Assignee: Rodeo Turtle LLC, Wellington, CO (US)

(21) Appl. No.: 16/783,246

(22) Filed: Feb. 6, 2020

(51) Int. Cl. B66F 9/20; B66F 9/12; B62B 3/06; B66F 9/065; B66F 9/22

(52) U.S. Cl. CPC B66F 9/205; B66F 9/12; B62B 3/0625; B62B 2203/10; B66F 9/22; B62B 3/0618; B66F 9/065

(57) ABSTRACT

A lift releasably coupled to a carrier and methods of making the lift or the carrier and methods of using embodiments of the lift which lift disposed in a retracted condition releasably couples to the carrier engaged to a support surface with the rotatable members of the one or more lifts disengaged from the support surface, and using embodiments of the lift which in an extended condition engages the rotatable members with the support surface to lift the carrier and allow translation of the carrier over the support surface.

### I. FIELD OF THE INVENTION

A lift releasably coupled to a carrier and methods of making the lift or the carrier and methods of using embodiments of the lift which lift disposed in a retracted condition releasably couples to the carrier engaged to a support surface with the rotatable members of the one or more lifts disengaged from the support surface, and using embodiments of the lift which in an extended condition engages the rotatable members with the support surface to lift the carrier and allow translation of the carrier over the support surface.

### II. SUMMARY OF THE INVENTION

A broad object of a particular embodiment of the invention can be to provide a height adjustable lift operable to move a lift member in axial spatial relation to a lift housing between an extended condition and a retracted condition, the lift having a rotatable member coupled to the lift member and having a lift arm outwardly extending from the lift housing in annular spaced relation about said rotatable member in retracted condition of said lift member with a lift arm terminating in a lift arm end radially and axially outward of said rotatable member in said retracted condition, and a lift head connected to said lift arm end, the lift head extending radially outward in relation to said lift member, said lift head adapted to releasably couple to a carrier lift head receiver.

Another broad object of a particular embodiment of the invention can be to provide a carrier configured to couple to the height adjustable lift, including a carrier lift head receiver configured to engage the lift head of a lift, and with the carrier engaged to a support surface and having the lift head engaged with the carrier lift head receiver with the lift in a retracted condition disposes the rotatable member a distance above the support surface engaged to said carrier.

Another broad object of particular embodiments of the invention can be to provide a lift having a lift head configured to telescopically engage a carrier lift head receiver of a carrier allowing telescoping adjustment of the lift proximal or distal from the carrier. In particular embodiments, a first one of said pair of lifts has a first lift head coupled to a first carrier lift head receiver to dispose the first one of said pair of lifts proximate to the carrier, and a second one of said pair of lifts has second lift head coupled to a second carrier lift head receiver to dispose the second one of said pair of lifts distal to the carrier relative to said first one of said pair of lifts.

Another broad object of the invention can be to provide a method in a combination of a height adjustable lift and a carrier, where the lift operates to move a lift member in axial spatial relation to a lift housing between an extended condition and a retracted condition, the lift having a rotatable member coupled to the lift member and having a lift arm outwardly extending from the lift housing in annular spaced relation about said rotatable member in retracted condition of said lift member with a lift arm terminating in a lift arm end radially and axially outward of said rotatable member in said retracted condition, and a lift head connected to said lift arm end, the lift head extending radially outward in relation to said lift member, and where the carrier includes a carrier lift head receiver configured to engage the lift head of the lift, the method including one or more of releasably engaging one or more lift heads with corresponding one or more carrier lift head receivers to dispose the corresponding one or more rotatable members a distance above the support surface engaged to the carrier, operating the corresponding one or more lift member drivers to correspondingly drive the one or more lift members toward the extended condition to engage the corresponding one or more rotatable members with the support surface to lift the carrier to a distance above the support surface, and moving the carrier over the support surface by rotation of the rotatable members.

Naturally, further objects of the invention are disclosed throughout other areas of the specification, drawings, photographs, and claims.

### III. BRIEF DESCRIPTION OF THE DRAWINGS

FIG. 1 is an illustration of a method of releasably engaging a plurality of lifts in the retracted condition to a carrier engaged to a support surface with the rotatable members of the plurality of lifts a distance “W” above the support surface engaged with the carrier.

FIG. 2 is an illustration of a method of operating the plurality of lifts in FIG. 1 to engage the support surface engaged with the carrier and lift the carrier a distance “X” above the support surface.

FIG. 3 is an illustration of a method of releasably engaging a lift head of one of the plurality of lifts in FIG. 1 with a carrier lift head receiver to dispose the rotatable member at distance “W” above the support surface engaged with the carrier.

FIG. 4 is an illustration of a method of releasably engaging a plurality of lifts in the retracted condition to a carrier having a device mounted to a carrier first face and having the carrier second face engaged to a support surface with the rotatable members of the plurality of lifts a distance “W” above the support surface engaged with the carrier.

FIG. 5 is an illustration of a method of operating the plurality of lifts in FIG. 4 to engage the support surface engaged with the carrier and lift the carrier with the device a distance “X” above the support surface.

FIG. 6 is an illustration of a method of releasably engaging a pair of lifts to a carrier where the first lift of the pair of lifts is disposed proximate the carrier having the rotatable member engaged to the support surface having a support surface first elevation, and where the second lift of the pair of lifts is disposed distal the carrier having the rotatable member engaged to the support surface having a support surface second elevation.

FIG. 7 is an illustration of a method of releasing a plurality of pairs of lifts from a he carrier shown in FIG. 6.

FIG. 8 is first perspective view of a particular embodiment of an inventive lift disposed in the retracted condition having the rotatable member a distance “W” above the support surface.

FIG. 9 is a second perspective view of the particular embodiment of the inventive lift disposed in the extended condition having lift head disposed a distance “X” above the support surface.

FIG. 10 is first side elevation view of a particular embodiment of the inventive lift disposed in the retracted condition having the rotatable member a distance “W” above the support surface.

FIG. 11 is second side elevation view of a particular embodiment of the inventive lift disposed in the retracted condition having the rotatable member a distance “W” above the support surface.

FIG. 12 is first plan view of a particular embodiment of the inventive lift.

FIG. 13 is second plan view of a particular embodiment of the inventive lift.

FIG. 14 is a first end elevation view of a particular embodiment of the inventive lift.

FIG. 15 is a second end elevation view of a particular embodiment of the inventive lift.

FIG. 16 is an exploded view of a particular embodiment of the inventive lift.

FIG. 17 is a cross section view 17-17 shown in FIG. 16 of a particular embodiment of the inventive lift.

FIG. 18 is block flow diagram of a particular method of using embodiments of the invention.

### IV. DETAILED DESCRIPTION OF THE INVENTION

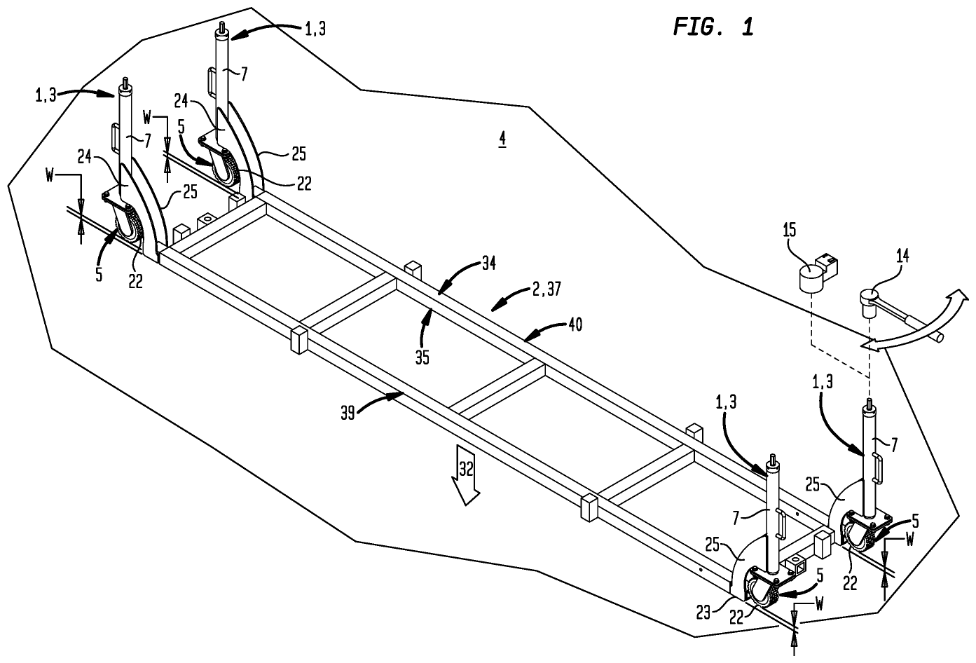

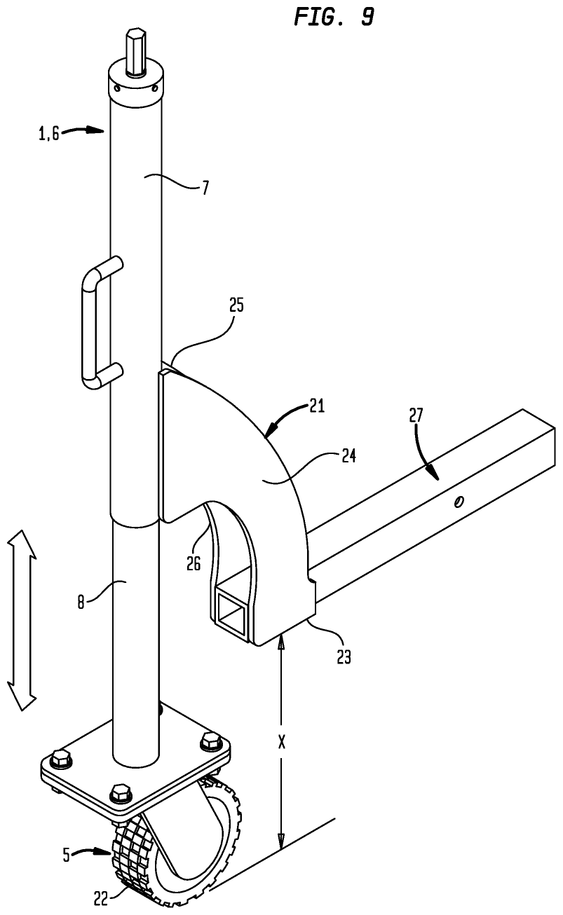

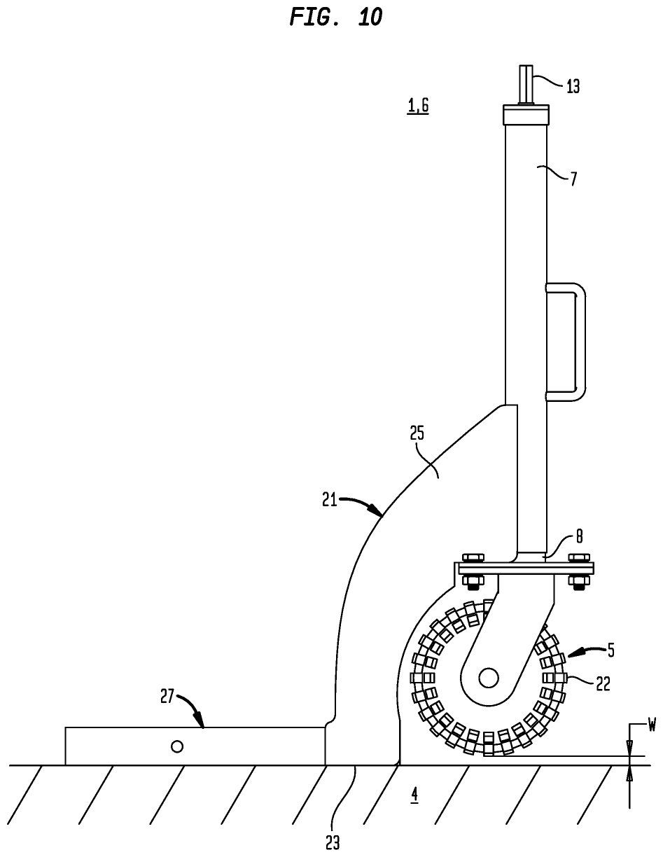

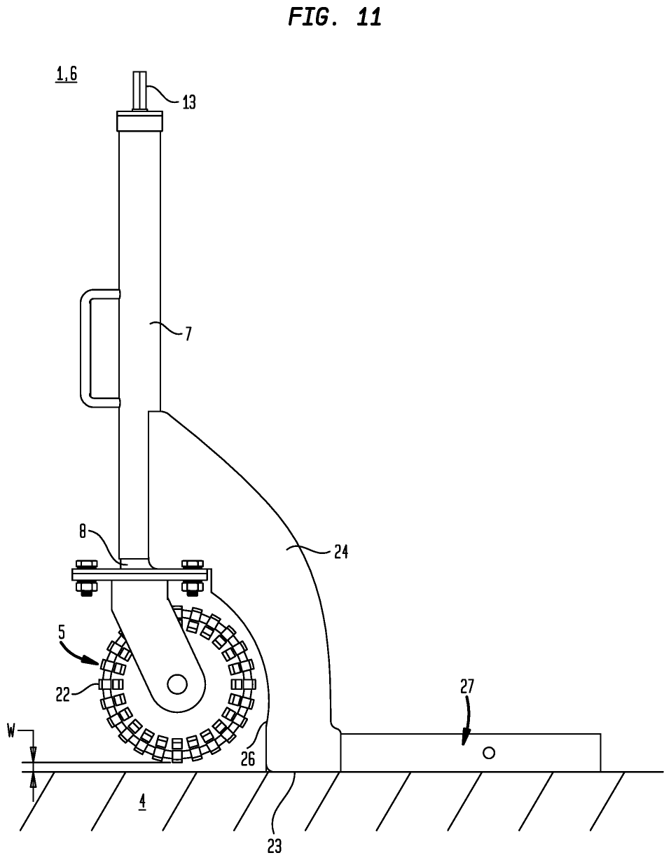

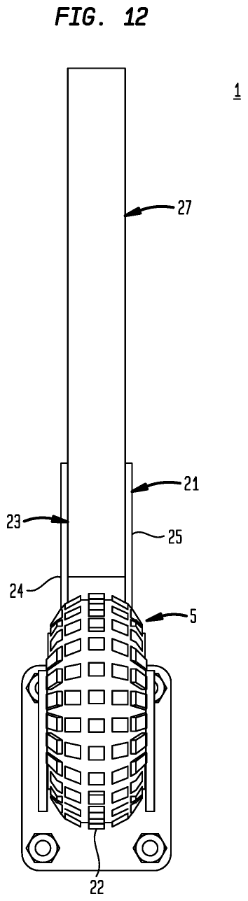

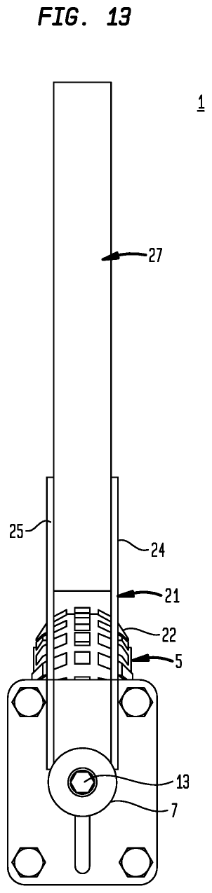

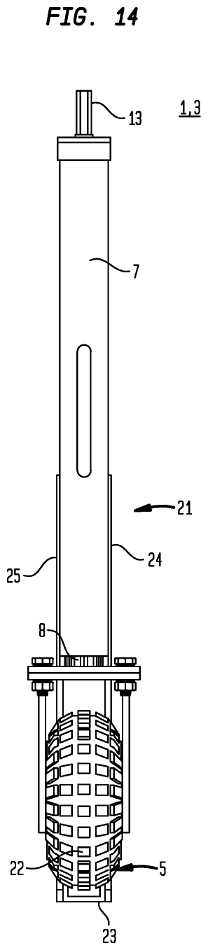

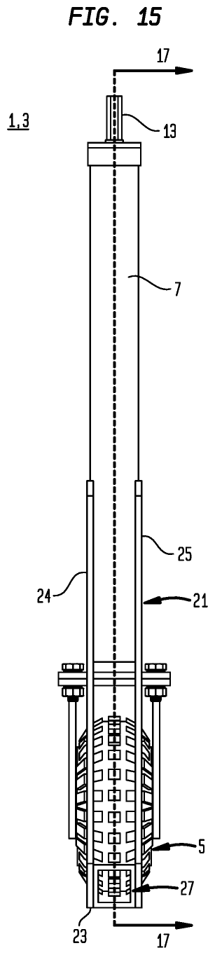

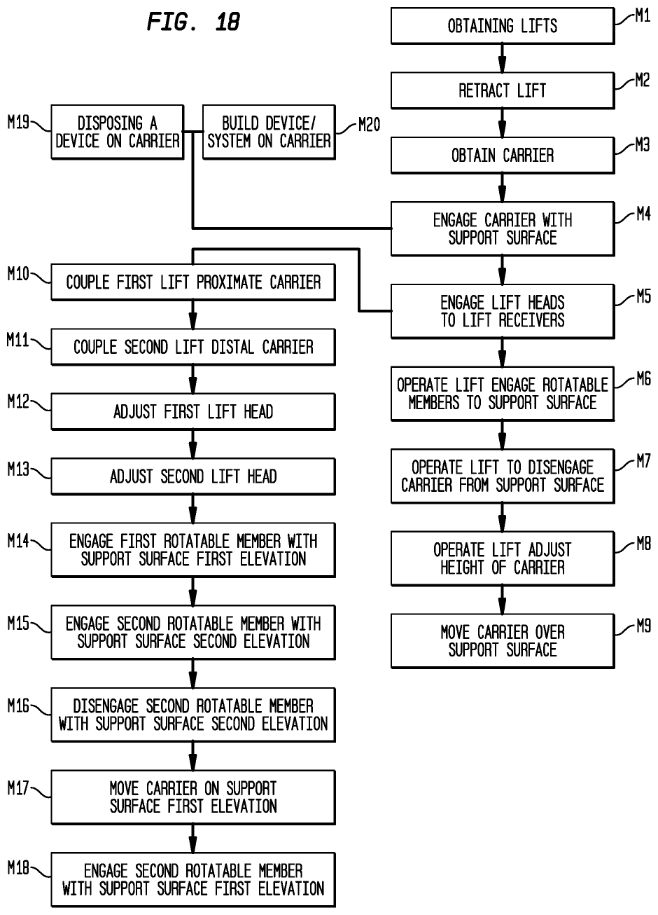

Now, with general reference to FIGS. 1 through 18, which depict embodiments of a lift (1) of which one or more can be releasably coupled to a carrier (2) and methods of making the lift (1) and the carrier (2) and methods of using one or more lifts (1) which in a retracted condition (3) can be releasably coupled to a carrier (2) engaged to a support surface (4) with rotatable member(s) (5) of the one or more lifts (1) disengaged from the support surface (4), and which in the extended condition (6) can engage the rotatable member(s) (5) with the support surface (6) to lift the carrier (2) from the support surface (4) to allow translation of the carrier (2) over the support surface (6).

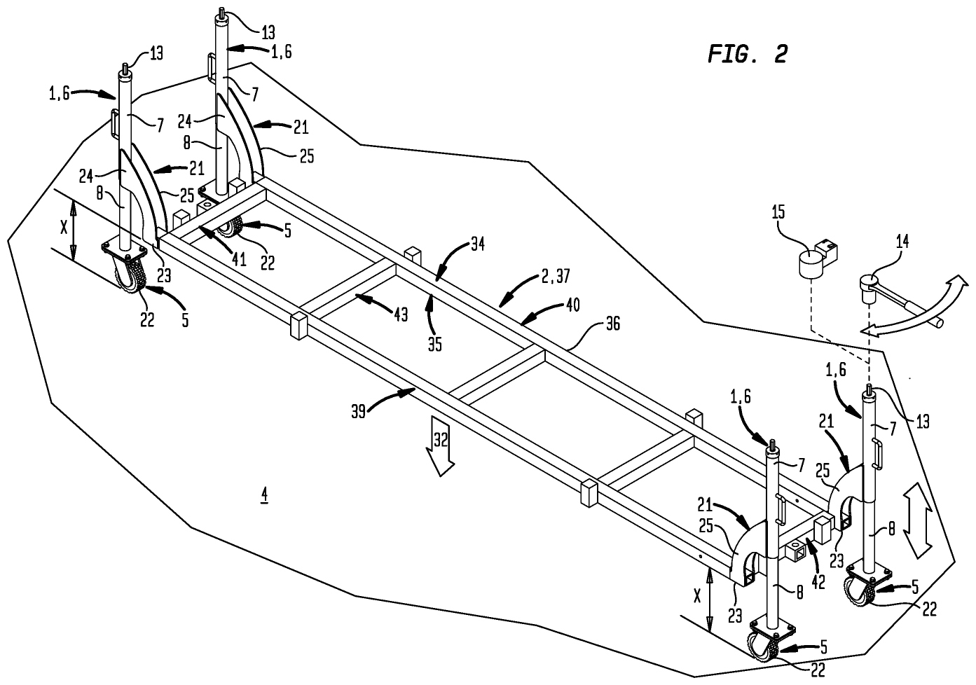

Now, with primary reference to FIGS. 1 through 17, embodiments can include a lift (1). Embodiments of the lift (1) can include a lift housing (7) and a lift member (8) coupled in movable spatial relationship to the lift housing (7) (as shown in the illustrative examples of FIGS. 1 and 2 respectively depicting the retracted condition (3) and the extended condition (6)). In particular embodiments, the lift member (8) telescopingly engages the lift housing (7). The lift housing (7) and lift member (8) can, but need not necessarily, include telescopingly engaged tubular cylinders having a circular or oval cross section; however, this is not intended to preclude other lift housings (7) and lift members (8) having tubular configurations which may define other polygonal or nonpolygonal cross sections, such as, a triangle, a square, a rectangle, lozenge, stadium, or other cross section configurations capable of relative telescoping movement of the lift member (8) in axial spatial relation to the lift housing (7).

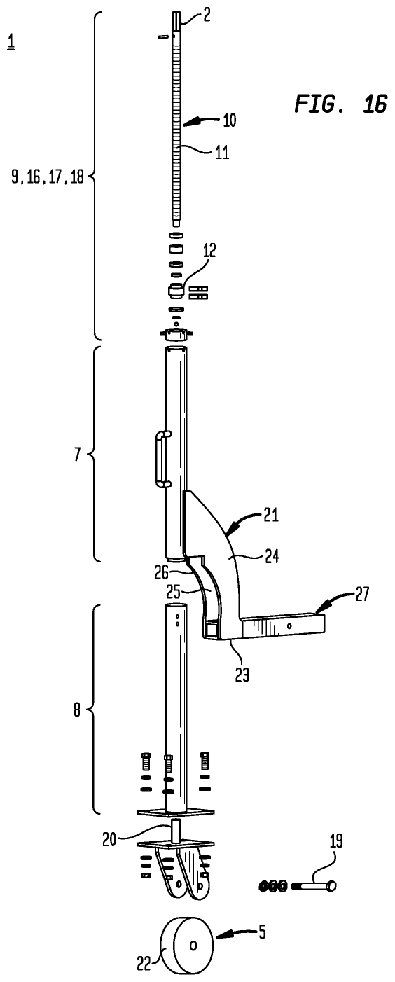

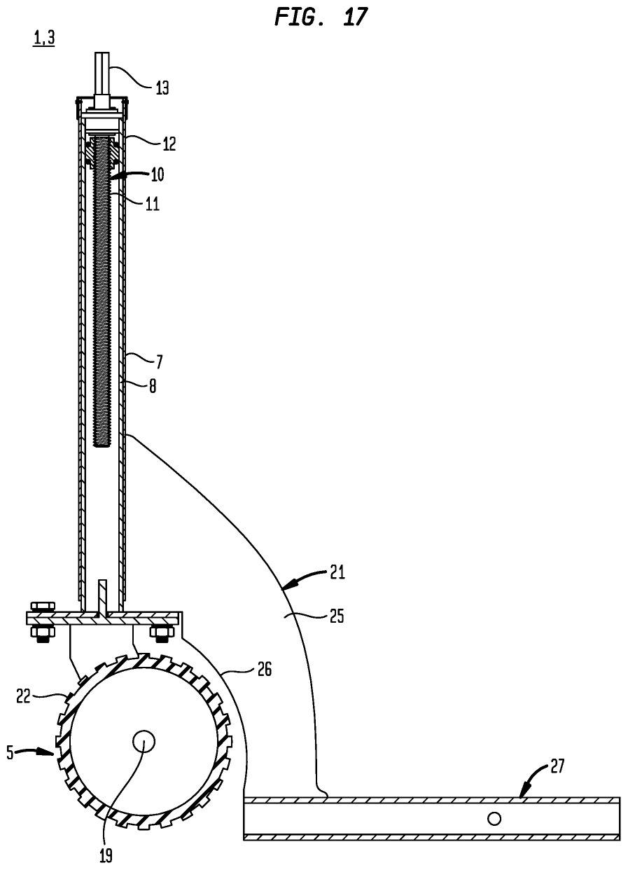

Again, with primary reference to FIGS. 1 through 17, embodiments can include a lift member driver (9) operable to move the lift member (8) in axial spatial relation to the lift housing (7) between a retracted condition (3) and an extended condition (6). In the illustrative example of FIGS. 16 and 17, the lift member driver (9) can, but need not necessarily, be a lead screw (10) including a threaded shaft (11) rotatably disposed in axial fixed spatial relation within said lift housing (7) telescopingly engaged to said lift member (8). An internally threaded annular member (12) can be threadingly engaged on the threaded shaft (11) and translate along the threaded shaft (11) upon rotation of said threaded shaft (11). The lift member (8) can be engaged to the internally threaded annular member (12) and correspondingly moves between the retracted condition (3) and an extended condition (6) of lift (1). In particular embodiments, the lead screw (10) can project outward of the lift housing (7) to terminate in a lead screw head (13) adapted to mate with a manual lever (14) or electric motor (15) operable to rotate the lead screw (10) in clockwise or counter clockwise rotation to correspondingly move the lift member (8) between the retracted condition (3) (as shown in the illustrative example of FIG. 1) and the extended condition (6) (as shown in the illustrative example of FIG. 2). However, these illustrative examples, are not intended to preclude embodiments in which the lift member driver (9) comprises a lift housing (7) and lift member (8) in the configuration of a rachet jack (16), a pneumatic cylinder (17) or a hydraulic cylinder (18) disposed in axial fixed spatial relation within the lift housing (7) telescopingly engaged to said lift member (8), the pneumatic cylinder (17) or a hydraulic cylinder (18) having a piston which translates within a cylinder, the lift member (8) coupled to the piston correspondingly moves between the retracted condition (3) and an extended condition (6) of lift

Again, with primary reference to FIGS. 1 through 17, embodiments can further include a rotatable member (5) responsive to movement of the lift member (8). The rotatable member (5) can comprise either a solid rotatable member or a pneumatic rotatable member rotatable about an axle (19) which can, but need not necessarily, orthogonally pivot about a pivot (20) coupled to the lift member (8). Movement of the lift member (8) between the retracted condition (3) and the extended condition (6) correspondingly moves the rotatable member (5) in relation to the lift housing (7).

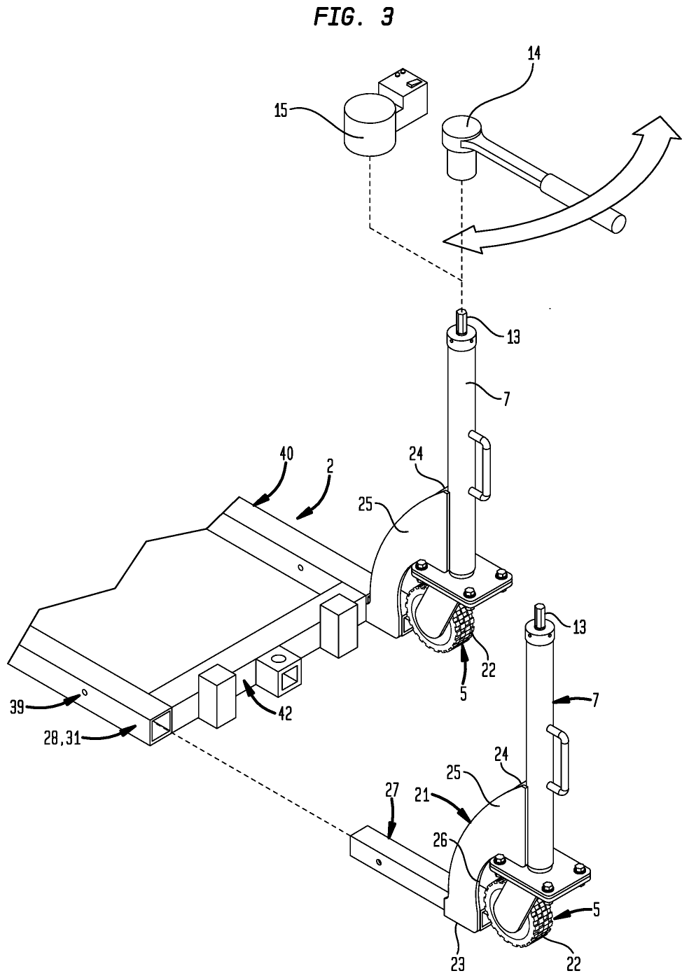

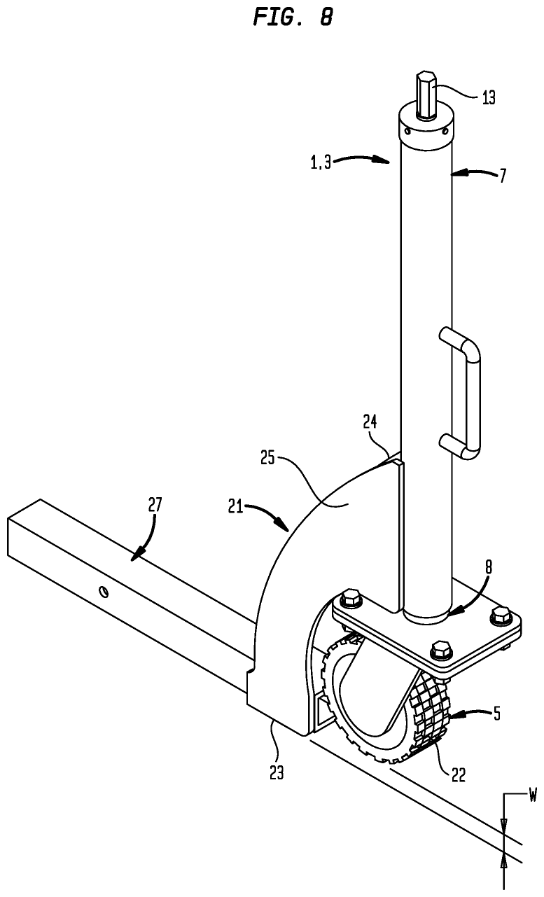

Again, with primary reference to FIGS. 1 through 17, the lift (1) can further include a lift arm (21) outwardly extending from the lift housing (7). As shown in the illustrative examples of FIGS. 8 through 15, the lift arm (21) extends in spaced annular relation to the rotatable member (5) to avoid contact with the rotatable member external surface (22), and terminates in a lift arm end (23) disposed radially outward of and axially below the rotatable member external surface (22) when the lift member (8) assumes the retracted condition (3). As shown in the illustrative example of FIGS. 1 and 8, with the lift arm end (23) in contact with the support surface (4) and with the lift member (8) disposed in the retracted condition (3), the rotatable member (5) can be disposed a distance (“X”) above the support surface (4). The embodiment of the lift arm (21) shown in FIGS. 3 and 8 includes a pair of planar members (24)(25) outwardly extending in substantially parallel relation from the lift housing (7). The pair of planar members (24)(25) extend to a lift arm periphery (26) which while shown as being arcuate to avoid contact with the rotatable member external surface (22) can take any configuration which avoids contact with the rotatable member (5), and while the planar members (24)(25) are shown as being continuous solids, this is not intended to preclude lift member arms (23) having one or more apertures open to opposite external surfaces. These illustrative examples of a lift arm (23) is not intended to preclude embodiments that may be one piece.

Again, with primary reference to FIGS. 1 through 17, the lift arm (21) can further include a lift head (27) coupled to the lift arm (23). The lift head (27) can be configured to releasably couple to a carrier lift head receiver (28) of a carrier (2). Now with primary reference to the illustrative examples of FIGS. 3 and 8, the lift head (27) can be coupled in spatially fixed radially outward extending relation to the lift arm (23) with a lift head external surface (29) configured to be releasably mateably received by the carrier lift head receiver (28). In particular embodiments, the lift head (27) can be configured as a tubular lift head (30) slidably or telescoping received within the carrier lift head receiver (28) configured as a tubular carrier lift head receiver (31) (as shown in the example of FIG. 3).

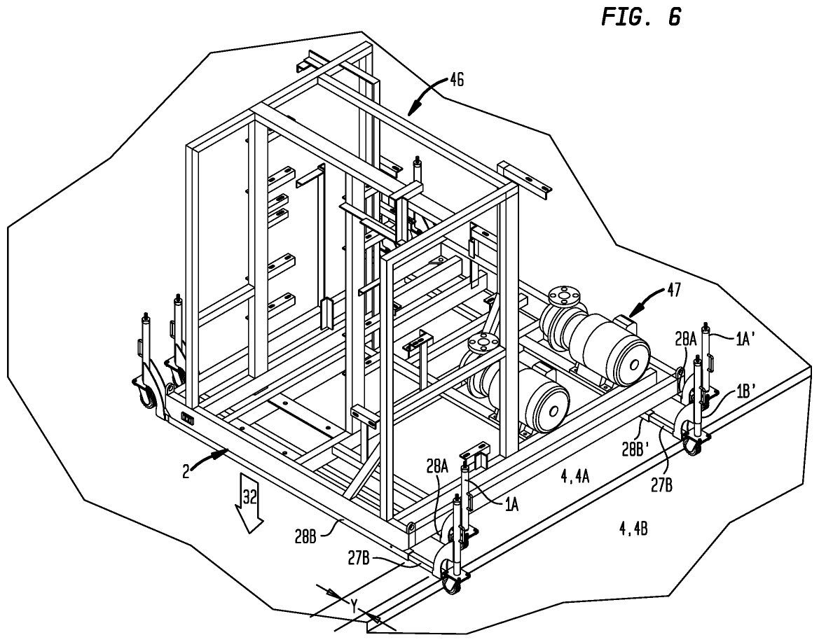

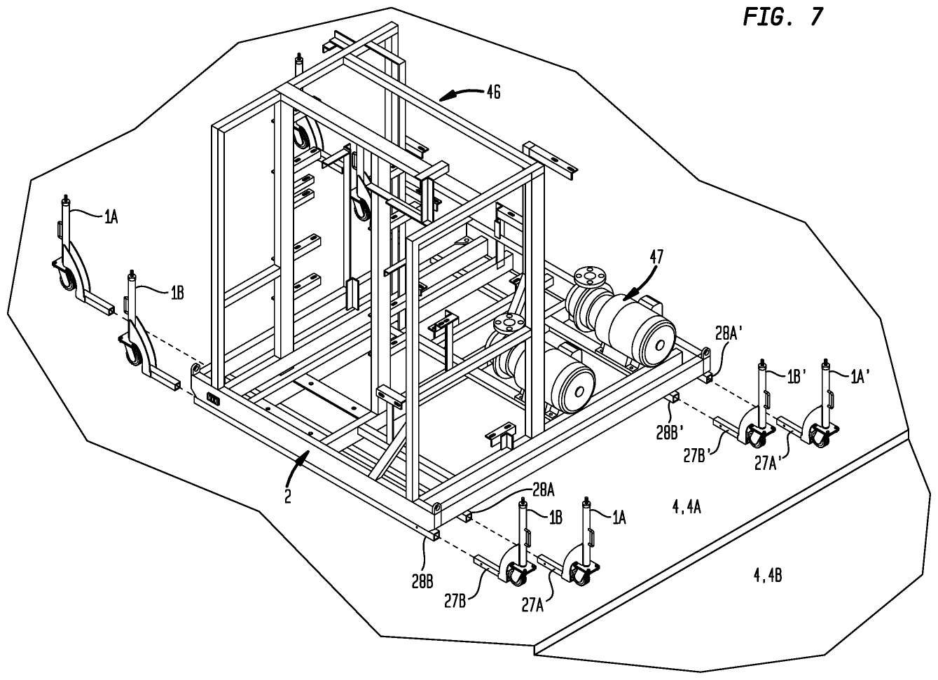

Now with primary reference to FIGS. 6 and 7, embodiments of the lift head (27) configured to be slidably or telescopingly received in the carrier lift head receiver (28) can confer substantial advantages by allowing a first lift (1A) to be adjusted relative to a second lift (1B). As shown in the illustrative example of FIG. 6, a first lift (1A) can be disposed proximate the carrier (2) by increasing the length of telescopic engagement of a first lift head (27A) with a first carrier lift receiver (28A), and the second lift (1B) can be disposed distal the carrier (2) by decreasing the length of telescopic engagement of a second lift head (27B) with a second carrier lift receiver (28B) to dispose the first lift (1A) proximate the carrier (2) and the second lift (1B) distal the carrier (2). There can be one or more substantial advantages in a lift head (27) having telescoping engagement with the carrier lift head receiver (28). In the first instance, a load (32) on the carrier (2) can be increased with use of a plurality of lifts (1). Secondly, the load (32) transferred from the carrier (2) to a plurality of lifts (1) can be distributed over a greater support surface area (33). Thirdly, there can be increased stability of the carrier (2) with use of a plurality of lifts (1). Fourthly, where the support surface (4) is not level but has a plurality of different support surface elevations (4A, 4B . . . 4ₙ), a first lift (1A) can transfer a first load (32A) to a first support surface elevation (4A) and a second lift (1B) can transfer a second load (32B) to a second support surface elevation (4B). While the illustrative example shows a pair of lifts (1A)(1B) disposed at different distances (“X”) from the carrier (2) by correspondingly adjusting telescopic engagement of the first lift head (27A) with the carrier lift head receiver (28A) and adjusting telescopic engagement of the second lift head (27B) with the second carrier lift head receiver (28B, this is not intended to preclude embodiments in which three, four, five or more lifts (1) can each be disposed at different distances (“X”) from the carrier (2) to afford one or more of the substantial advantages described herein or other advantages achieved through various permutations and combinations of the number of lifts (1) and varying the distance (“X”) of the lifts (1) from the carrier (2). However, these examples are not intended to preclude other configurations of the lift head (27) and carrier lift head receiver (28) as mateable parts of a connector, such peg and socket, flange and slot, telescoping tubes, or the like.

Now with primary reference to FIGS. 1 through 7, embodiments can include a carrier (2) having a carrier first face (34) opposite a carrier second face (35) extending to and joined at a carrier perimeter edge (36). In the illustrative embodiment shown in FIGS. 1 through 3, the carrier (2) comprises a carrier framework (37) including a plurality of carrier members (38) interconnected to form a rectangle having a pair of carrier side members (39)(40) and a pair of carrier end members (41)(42) with a plurality of crossmembers (43) extending between said pair of side members (39)(40). The carrier (2) being otherwise open between the carrier first face (34) and the carrier second face (35). However, this illustrative example is not intended to preclude a carrier (2) having other configurations have a partially closed or closed faces or having a polygonal perimeter or open nonpolygonal perimeter. As examples the carrier (2) can, but need not have a carrier perimeter edge (36) which defines any regular or irregular polygonal perimeter edge, but could also define a nonpolygonal edge such as a circle, an oval, or having curved and linear segments, or a discontinuous carrier perimeter edge (36), or any configuration of a carrier (2) to which one or more carrier lift head receiver(s)(28) can be coupled or releasably coupled to correspondingly engage one or more a lift head(s) (27) of one or more lifts (1). The term “coupled” depending on the embodiment encompasses direct or indirect attachment in fixed spatial relation to the carrier (2) subject to flexure or movement of the carrier (2) and carrier lift head receiver (28) during normal use.

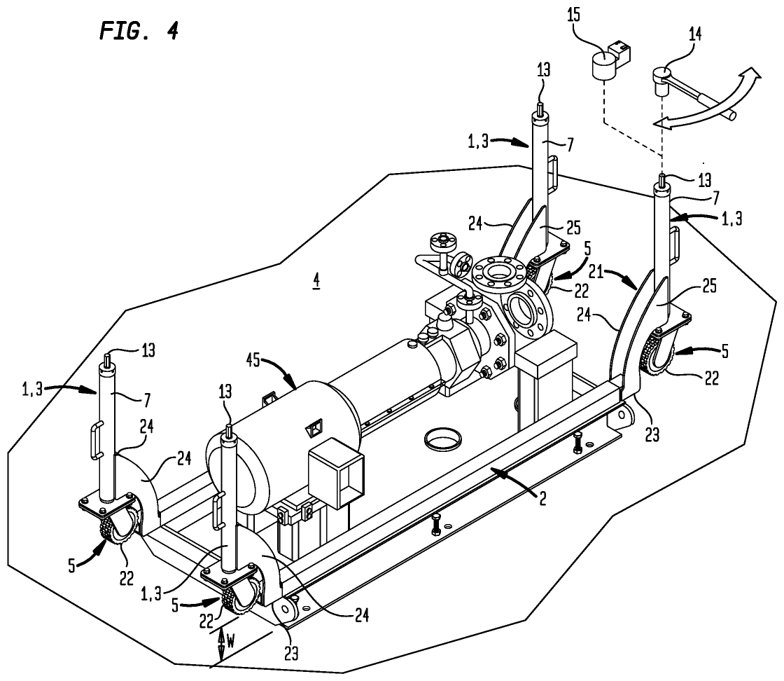

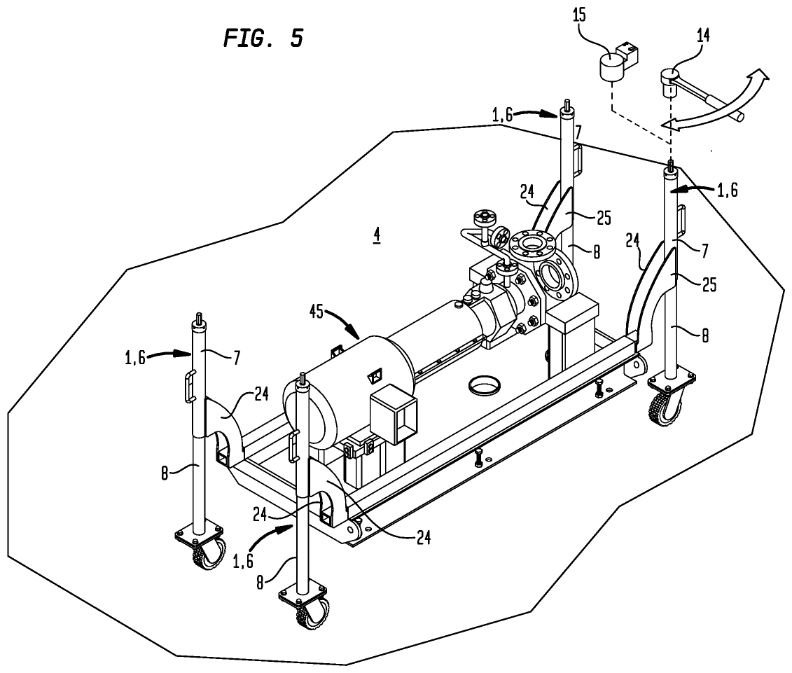

Now, with primary reference to FIGS. 4 through 7, embodiments can further include an apparatus, device or system (hereinafter referred to as a “device”) (45) built or disposed on the carrier (2). In particular applications, the carrier (2) can be engaged to a support surface (4) and a device (45) can, but need not necessarily, be disposed on or constructed upon the carrier (2). As shown in the examples of FIGS. 4 and 5, the device (45) can be mounted to a substantially planar carrier (2), while in the examples of FIGS. 6 and 7, the carrier (2) can include a support framework (46) on which a plurality of device components (47) can be attached in operable relationship. There can be substantial advantages to having a device (45) built or disposed on a carrier (2). In the first instance, certain devices (45) can weigh hundreds, thousands or tens of thousands of pounds which require apparatus on which to transport and subsequently secure the device (45) for operation. The carrier (2) fulfils the various requirements of a carrier (2) on which the device (45) can be assembled, a carrier (2) on which the device (45) can be transported, and a carrier (2) which can be permanently affixed for installation and operation of the device (45). Similarly, in the context of a system including a plurality of device components (45) which must be assembled in a particular operational structure, the carrier support framework (46) affords a framework or scaffold on which the device components can be affixed in an operational structure that can be transported and installed as an integrated operational whole.

Now, with primary reference to FIGS. 1 through 3 and FIG. 18, a method of using embodiments includes obtaining one or more lift(s) (1) (Block M1) comprising, consistent essentially of or consisting of one or more of the lift elements above described. The method can further include operating the lift member driver (9) to dispose the lift (1) in the retracted condition (3) (Block M2). The method can further include obtaining a carrier (2) (Block M3) comprising, consisting essentially of, or consisting of one or more of the carrier elements above described. The method can further include engaging the carrier (2) to a support surface (4) (Block M4). The method can further include releasably coupling the lift head(s) (27) of one or more lift(s) (1) correspondingly to one or more carrier lift head receiver(s) (28) of the carrier (2)(Block M5), whereby the lift (1) disposed in the retracted condition (3) and coupled to the carrier (2) disposes the rotatable member (5) at a distance (“W”) above the support surface.

Now, with primary reference to FIG. 2, the method can further include operating the lift member driver (s) (9) to move the lift member(0s)(1) toward the extended condition (6) to engage the rotatable member(s) (5) with said support surface (4)(Block M6), and can further include operating the lift member driver(s) (9) to disengage the carrier from the support surface (4)(Block M7), and can further include adjusting a carrier height (“X”) above the support surface (4) by operation of the lift member driver(s) (9) (Block M8). The method can further include moving the carrier (2) on the support surface (4) by rotating the rotatable members (5) of the lift(s) (1) coupled to the carrier (2) (Block M9).

Now, with primary reference to FIGS. 6 and 7, the method can further include coupling a pair of lifts (1A)(1B) to a carrier (2), wherein a first lift (1A) of the pair of lifts has a first lift head (27A) coupled to a first carrier lift head receiver (28A) to dispose the first lift (1A) of the pair of lifts (1A)(1B) proximate the carrier (2) (Block M10), and wherein a second lift (1B) of the pair of lifts (1A)(1B) has second lift head (27B) coupled to a second carrier lift head receiver (28B) to dispose the second lift (1B) of the pair of lifts (1A)(1B) distal to the carrier (2) relative to the first lift (1A) of the pair of lifts (1A)(1B)(Block M11). While FIG. 6 illustrates the pair of lifts (1A)(1B) proximate one another, being adjacent, or side by side (as shown by the example of lifts (1A)(1B)), the term a pair of lifts (1A)(1B) is intended to encompass a pair of lifts (1A)(1B) that may also be distal to one another (as shown by the example of lifts (1A)(1B′)).

Now, with primary reference to FIG. 6, embodiments of the method can further include slidably adjusting the first lift head (27A) of a first lift (1A) of a pair of lifts (1A)(1B) in relation to the first carrier lift head receiver (28A) to dispose the first lift (1A) proximate the carrier (2)(Block M12), and slidably adjusting the second lift head (27B) of a second lift (1B) of a pair of lifts (1A)(1B) to dispose a second lift (1B) of the pair of lifts (1A)(1B) distal from the carrier (2) relative to the first lift (1A) of the pair of lifts (1A)(1B (Block M13). The method can, but need not necessarily, further include engaging a rotatable member (5) of the first lift (1A) of the pair of lifts (1A)(1B) with a support surface (4) having a support surface first elevation (4A) (Block M14). The method can, but need not necessarily, include engaging the rotatable member (5) of the second lift (1B) of the pair of lifts (1A)(1B) with the support surface (4) having a support surface second elevation (4B)(Block M15). The method may further include operating the lift member driver (9) of the second lift (1B) of said pair of lifts (1A)(1B) to disengage the rotatable member (5) of the second lift (1B) from the support surface (4) having the support surface second elevation (4B) to a level above the support surface (4) having the support surface first elevation (4A) (Block M16). The method can further include moving the carrier (2) on the support surface (4) having the support surface first elevation (4A)(Block M17). The method may further include operating the lift member driver (9) of the second lift (1B) of said pair of lifts (1A)(1B) to engage the rotatable member (5) of the second lift (1B) with the support surface (4) having the support surface first elevation (4A) (Block M18), thereby moving the carrier (2) from the support surface (4) having a support surface first elevation (4A) to the support surface (4) having a support surface second elevation (4B). In particular embodiments of the method, the pair of lifts (1A)(1B) can comprise a plurality of pairs of lifts (1A)(1B)(1A′)(1B′) . . . (1.Aⁿ)(1Bⁿ), each pair of lifts (1A)(1B) of the plurality of pairs of lifts (1A)(1B)(1A′)(1B′) . . . (1Aⁿ)(1Bⁿ) operable as above described to allow a carrier (2) to be moved from a support surface (4) having a support surface first elevation (4A) to a support surface (4) having a support surface second elevation (4B). The method applicable whether the support surface first elevation (4A) relative to the support surface second elevation (4B) has greater or lesser support surface elevation.

Now with primary reference to FIGS. 4 through 7, embodiments of the method can, but need not necessarily, include disposing a device (45) on the carrier (2) (Block M19), or in particular embodiments, the method can further include building a device (4) on the carrier (2) (Block M20).

As can be easily understood from the foregoing, the basic concepts of the present invention may be embodied in a variety of ways. The invention involves numerous and varied embodiments of a lift (1) or a carrier (2) and combinations thereof and methods for making and using such lift (1)or carrier (1) or combinations thereof, including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “lift” should be understood to encompass disclosure of the act of “lifting”—whether explicitly discussed or not—and, conversely, were there effectively disclosure of the act of “lifting”, such a disclosure should be understood to encompass disclosure of a “lift” and even a “means for lifting.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the lifts or carriers or combinations thereof herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An apparatus, comprising:
a lift including:
a lift housing;
a lift member coupled in movable spatial relationship to said lift housing;
a lift member driver operable to move said lift member in axial spatial relation to said lift housing between an extended condition and a retracted condition;
a rotatable member responsive to movement of said lift member;
a lift aim outwardly extending from said lift housing in annular spaced relation about said rotatable member in said retracted condition of said lift member, said lift arm terminating in a lift arm end radially and axially outward of said rotatable member in said retracted condition; and
a lift head connected to said lift arm end, said lift head extending radially outward in relation to said lift member, said lift head adapted to releasably couple to a carrier lift head receiver.

2. The apparatus of claim 1, further comprising a carrier including said carrier lift head receiver, said lift head engages said carrier lift head receiver with said carrier engaged to a support surface, said lift in said retracted condition having said lift head engaged with said carrier lift head receiver disposes said rotatable member a distance above said support surface engaged to said carrier.

3. The apparatus of claim 2, wherein said lift member driver operable to move said lift member toward the extended condition to engage said rotatable member with said support surface to lift said carrier a distance above said support surface.

4. The apparatus of claim 3, wherein said lift member telescopingly engages said lift housing, said lift member driver capable of causing relative telescopic movement of said lift member in axial spatial relation to said lift housing.

5. The apparatus of claim 4, wherein said lift member driver comprises a lead screw including a threaded shaft rotatably disposed in axial fixed spatial relation within said lift housing telescopingly engaged to said lift member, a internally threaded annular member threadingly engaged on said threaded shaft, said internally threaded annular member translates along said threaded shaft upon rotation of said threaded shaft, said lift member engaged to said internally threaded annular member correspondingly moves between said extended condition and said retracted condition.

6. The apparatus of claim 5, wherein said lead screw terminates in a lead screw head outwardly axially projecting from said lift housing, said lead screw head adapted to mate with a manual lever or electric motor to rotate said threaded shaft.

7. The apparatus of claim 4, wherein said lift member driver comprises a pneumatic cylinder or a hydraulic cylinder disposed in axial fixed spatial relation within said lift housing telescopingly engaged to said lift member, said pneumatic cylinder or a hydraulic cylinder having a piston which translates within a cylinder, said lift member coupled to said piston correspondingly moves between said extended condition and said retracted condition.

8. The apparatus of claim 4, wherein said lift member driver is selected from the group consisting of a lead screw, pneumatic cylinder, and a hydraulic cylinder.

9. The apparatus of claim 2, further comprising a device disposed on or assembled on said carrier.

10. The apparatus of claim 9, wherein said carrier further comprises a support framework, and a plurality of components, said plurality of components attached in operational relationship to said support frame comprises said device.

11. The apparatus of claim 2, wherein said lift comprise a plurality of lifts releasably coupled to said carrier, said plurality of lifts disposing each of said plurality of lift members in the retracted condition and engaging each of a plurality of lift heads to a corresponding one of a plurality of carrier lift head receivers of said carrier, wherein said plurality of lifts coupled to said carrier disposes each of a corresponding plurality of rotatable members a distance above said support surface.

12. The apparatus of claim 11, wherein said plurality of lifts each correspondingly include one of a plurality of lift member drivers, said plurality of lift member drivers operated to move said lift member from said retracted condition toward said extended condition to lift said carrier a distance above said support surface.

13. The apparatus of claim 2, wherein said lift comprises a pair of lifts, wherein a first one of said pair of lifts has a first lift head coupled to a first carrier lift head receiver to dispose said first one of said pair of lifts proximate to said carrier, and wherein a second one of said pair of lifts has second lift head coupled to a second carrier lift head receiver to dispose said second one of said pair of lifts distal to said carrier relative to said first one of said pair of lifts.

14. The apparatus of claim 13, wherein said first one of said pair of lifts disposed proximate said carrier capable of engaging said rotatable member with said support surface having a support surface first elevation, wherein said second one of said pair of lifts disposed distal said carrier capable of engaging said rotatable member with said support surface having a support surface second elevation.

15-40 (canceled)
